(19) United States
(12) Patent Application Publication
(10) Pub. No.: US 2014/0126140 A1
(43) Pub. Date: May 8, 2014

(54) Removable Computer Component Module

(71) Applicant: ISG INDUSTRIAL CO., INC., New Taipei City (TW)

(72) Inventors: Kuo-Hsin Wang, New Taipei City (TW); Chun-Lan Hsiao, New Taipei City (TW)

(73) Assignee: ISG INDUSTRIAL CO., INC., New Taipei City (TW)

(21) Appl. No.: 13/760,152

(22) Filed: Feb. 6, 2013

(30) Foreign Application Priority Data
Nov. 5, 2012 (TW) 101221402

(51) Int. Cl. G06F 1/16

(52) U.S. Cl. CPC G06F 1/16
USPC 361/679.37

(57) ABSTRACT

A removable computer component module includes a plurality of drive trays each adapted for receiving a computer component. Each of the plurality of drive trays includes front and back ends at two lateral opposite ends thereof, two first and two second engaging portions arranged at two vertical opposite ends thereof. The two first and two second engaging portions horizontally extended from the front end to the back end. The two first engaging portions of one of the plurality of drive trays are engageable with the second engaging portions of the other of the plurality of drive trays to form a vertical array without tools.

### BACKGROUND OF THE INVENTION

1. Field of the Invention

The present invention relates generally to a computer component module, and, more particular, to a removable computer component module adapted to be assembled quickly without fasteners and tools to form a vertical array.

2. Description of the Related Art

U.S. Pat. No. 6,356,441 discloses a data storage system, which includes a main assembly and a disk drive assembly. The main assembly includes a support structure that defines an opening through which the disk drive assembly enters and exits. The disk drive assembly includes a housing, a disk drive, a daughter card and a lever. The housing includes guides, which facilitate motion of the housing of the disk drive assembly within the support structure of the main assembly, but the housing cannot be attached with the main assembly securely. Moreover, there is no position device arranged between the main assembly and the disk drive assembly to cause connectors of a hard disk drive received in the disk drive assembly being loosen easily due to the vibration of the hard disk drive caused operating thereof.

U.S. Pat. No. 6,231,145 discloses a mobile rack assembly for hard disk driver. The mobile rack assembly includes a mounting bracket having two aluminum extrusion plates formed on both sides thereof and each having a guiding rail. A mobile rack is arranged within the mounting bracket and having an aluminum extrusion stage which has a plurality of sliding rails for slidably engaging the guiding rails of said mounting bracket. Hence, when the hard disk driver operates, the mounting bracket and the mobile rack will be vibrated to cause a problem that they can not engage with each other precisely.

U.S. Pat. No. 6,378,965 discloses a disk drive bracket. Sides of the disk drive bracket are formed with holes for passage of screws to make electrical and mechanical contact with the sides of the hard disk drive. Spring clips formed of metal and curved in shape are held at the front and back end of each side by screws passing through holes. The spring clips engage the sides of a chassis of a computer in resilient fashion. Hence, vibration of the disk drive within the chassis is damped both vertically and horizontally. However, the spring clips will rub against the sides of the chassis to produce noise pollution.

The present invention is, therefore, intended to obviate or at least alleviate the problems encountered in the prior art.

### SUMMARY OF THE INVENTION

The present invention solves this need and other problems in the field of computer hardware components by providing a removable computer component module including a plurality of drive trays each adapted for receiving a computer component. Each of the plurality of drive trays includes front and back ends at two lateral opposite ends thereof, two first and two second engaging portions arranged at two vertical opposite ends thereof. The two first and two second engaging portions horizontally extended from the front end to the back end. The two first engaging portions of one of the plurality of drive trays are engageable with the second engaging portions of the other of the plurality of drive trays to form a vertical array.

Preferably, each of the two first engaging portions includes a sliding slot horizontally extended from the front end to the back end. Each of the two second engaging portions includes a sliding rail horizontally extended from the front end to the back end and corresponding to the sliding slot of each of the two first engaging portions. The sliding rail of each of the two second engaging portions is engageable into the sliding slot of each of the two first engaging portions, so that the plurality of drive trays are stacked with each other to form the vertical array.

In an example, the sliding slot of each of the two first engaging portions has a reversed T-shaped cross section corresponding to a reversed T-shaped cross section of the sliding rail of each of the two second engaging portions.

In another example, the sliding slot of each of the two first engaging portions of each of the plurality of drive trays has a circular cross section corresponding to a circular cross section of the sliding rail of each of the two second engaging portions of each of the plurality of drive trays.

In a further example, the sliding slot of each of the two first engaging portions of each of the plurality of drive trays has a arrow-shaped cross section corresponding to a arrow-shaped cross section of the sliding rail of each of the two second engaging portions of each of the plurality of drive trays.

In a different example, the sliding slot of each of the two first engaging portions of each of the plurality of drive trays has a trapezoid-shaped cross section corresponding to a trapezoid-shaped cross section of the sliding rail of each of the two second engaging portions of each of the plurality of drive trays.

In a further example, the sliding slot of each of the two first engaging portions of each of the plurality of drive trays has a reversed L-shaped cross section corresponding to a reversed L-shaped cross section of the sliding rail of each of the two second engaging portions of each of the plurality of drive trays.

Preferably, the removable computer component module further includes a housing adapted for receiving the vertical array formed by the plurality of drive trays.

The housing is made of an extruded aluminum, which is a good thermal conductor, and reduces die costs. Additionally, the extruded aluminum housing has a metallic appearance looking more precious than that made of plastic, and can easily be cropped in accordance with a height of the vertical array for interoperability to reduce manufacturing cost.

The housing includes a bottom section, and two third engaging portions formed at two opposite lateral ends of the bottom section and corresponding to and engageable with the two second engaging portions of one of the plurality of drive trays.

Preferably, the positioning slot of each of the third engaging portions has a reversed T-shaped cross section corresponding to that of the sliding rail of each of the two second engaging portions, and engageable with the sliding rail of each of the two second engaging portions of the nethermost drive tray of the vertical array.

Preferably, the removable computer component module further includes a plurality of damping devices each are connected to each of the two lateral portions of each of the plurality of drive trays to reduce the friction and provide the damping function.

It is an object of the present invention to provide the two second engaging portions of one of the plurality of the drive trays engageable with the two first engaging portions of another of the plurality of the drive trays to be quickly stacked with each other to form a vertical array without tools. Other objects, advantages, and new features of the present invention will become apparent from the following detailed description of the invention when considered in conjunction with the accompanied drawings.

### BRIEF DESCRIPTION OF THE DRAWINGS

The illustrative embodiments may best be described by reference to the accompanying drawings where:

FIG. 1 shows a perspective view of a removable computer component module of a first embodiment according to the present invention.

FIG. 2 shows an exploded, perspective view of the removable computer component module of FIG. 1.

FIG. 3 shows another exploded, perspective view of the removable computer component module of FIG. 1.

FIG. 4 shows a cross-sectional view taken along line 4-4 of FIG. 1.

FIG. 5 shows a partial, enlarged view of the removable computer component module shown in FIG. 4.

FIG. 6 shows a cross-sectional view taken along line 6-6 of FIG. 1.

FIG. 7 shows another cross-sectional view of FIG. 1.

FIG. 8 shows a cross-sectional view of FIG. 1, and illustrates a computer component received into a drive tray.

FIG. 9 shows a continued cross-sectional view of FIG. 8, and illustrates the computer component positioned in the drive tray by a stopper.

FIG. 10 shows a cross-section view of a removable computer component module of a second embodiment according to the present invention.

FIG. 11 shows a partial, enlarged view of the removable computer component module shown in FIG. 10.

FIG. 12 shows a cross-section view of a removable computer component module of a third embodiment according to the present invention.

FIG. 13 shows a cross-section view of a removable computer component module of a fourth embodiment according to the present invention.

FIG. 14 shows a cross-section view of a removable computer component module of a fifth embodiment according to the present invention.

FIG. 15 shows a cross-section view of a removable computer component module of a sixth embodiment according to the present invention.

FIG. 16 shows a cross-section view of a removable computer component module of a seventh embodiment according to the present invention.

FIG. 17 shows a cross-section view of a removable computer component module of an eighth embodiment according to the present invention.

FIG. 18 shows a cross-section view of a removable computer component module of a ninth embodiment according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “end”, “portion”, “longitudinal”, “radial”, “diameter”, “width”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE PREFERRED EMBODIMENTS

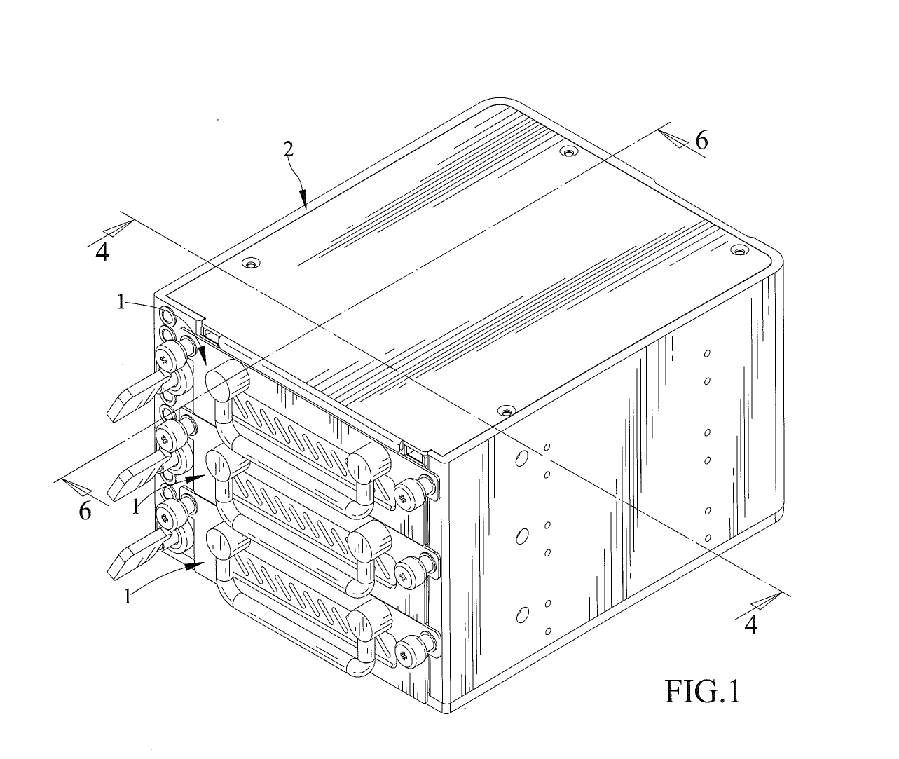

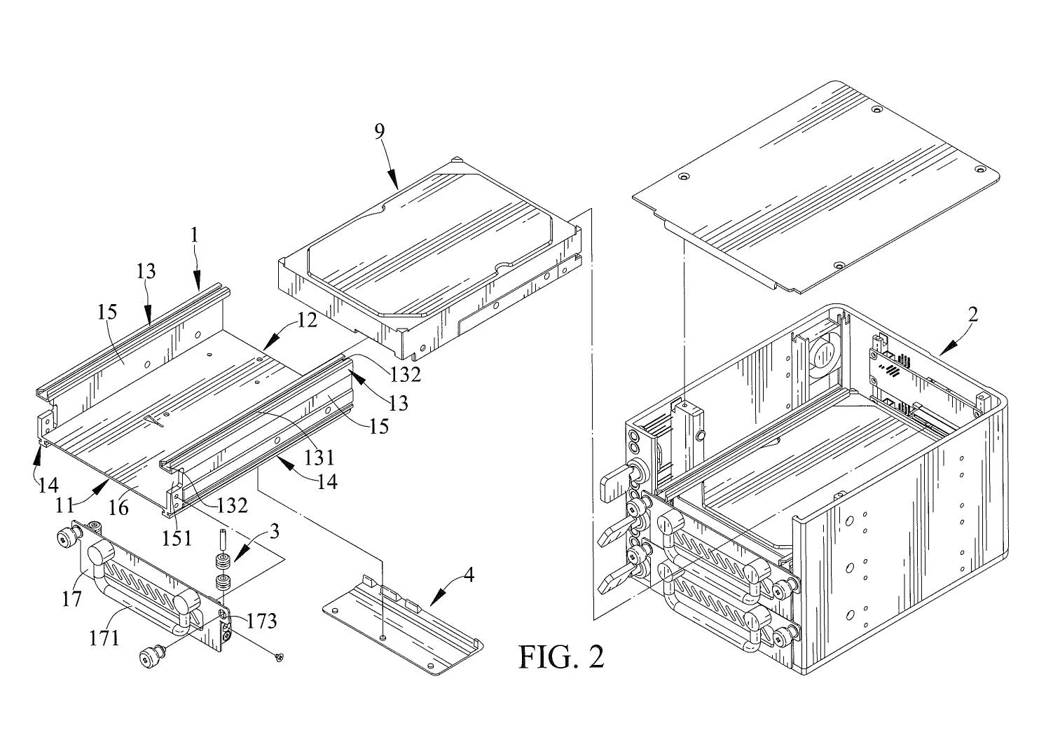

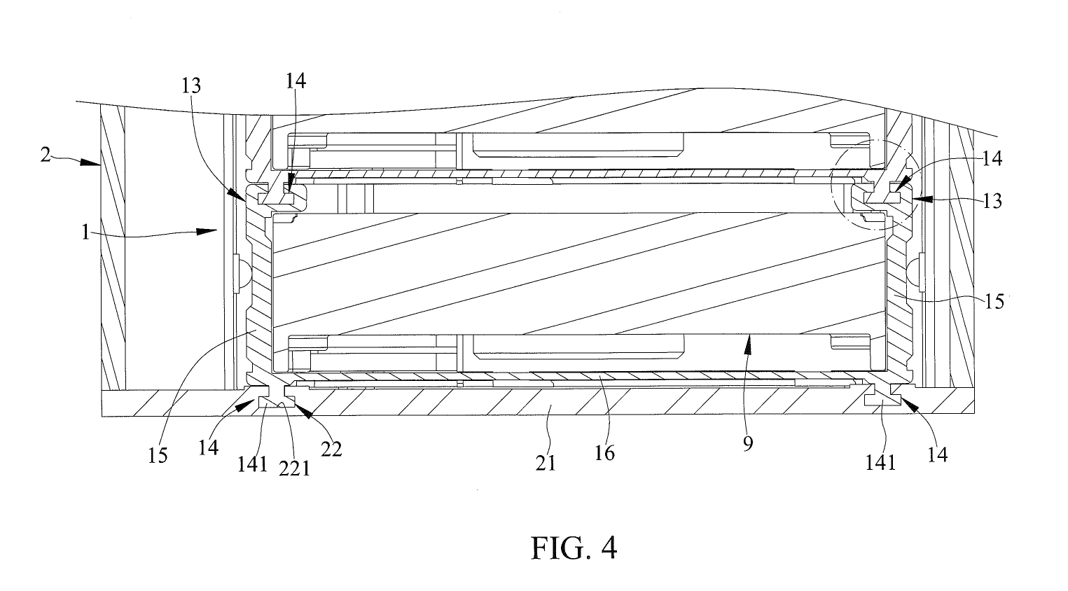

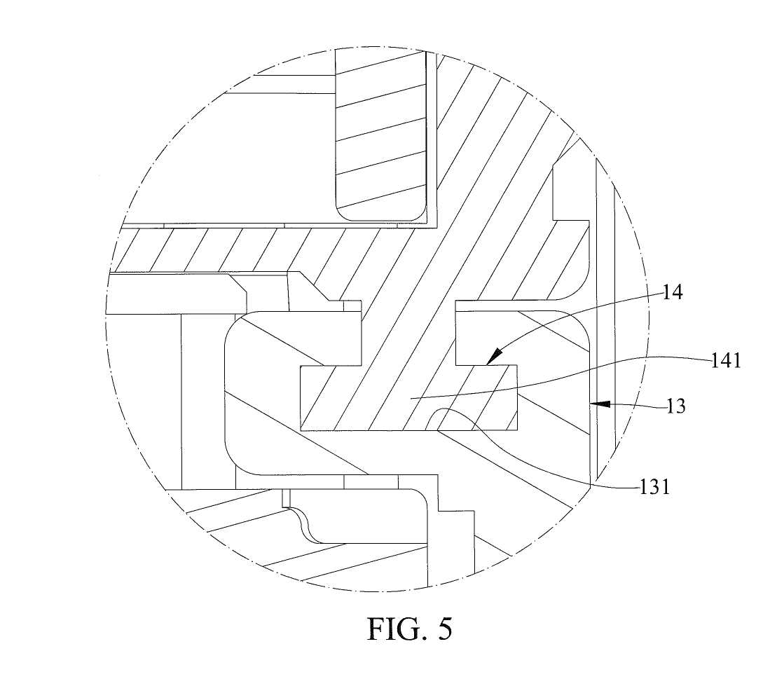

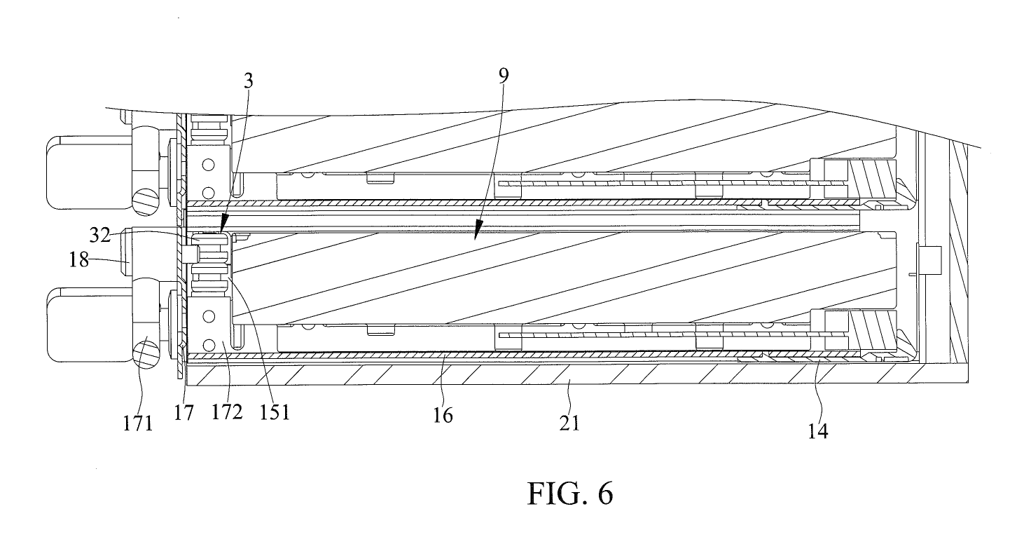

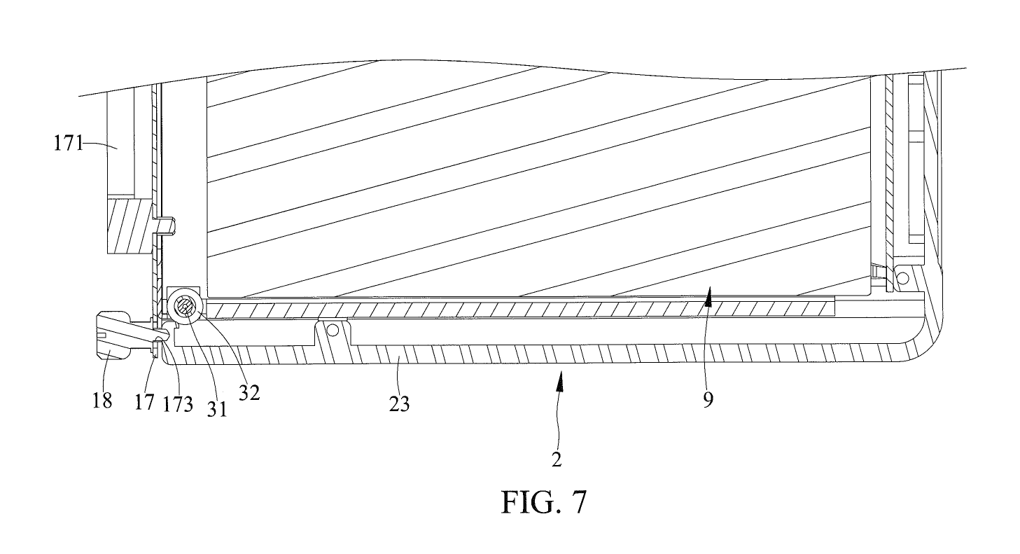

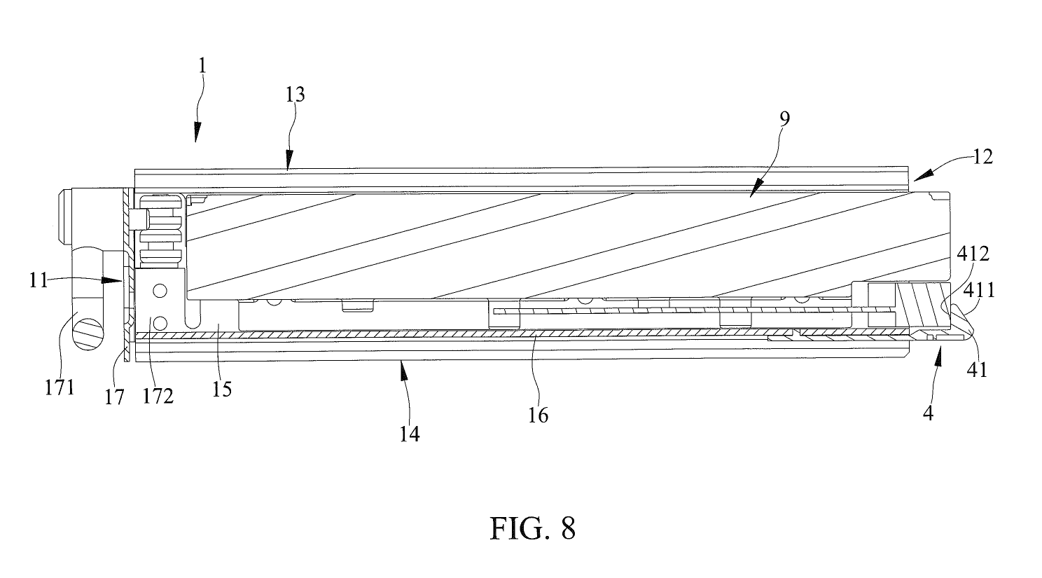

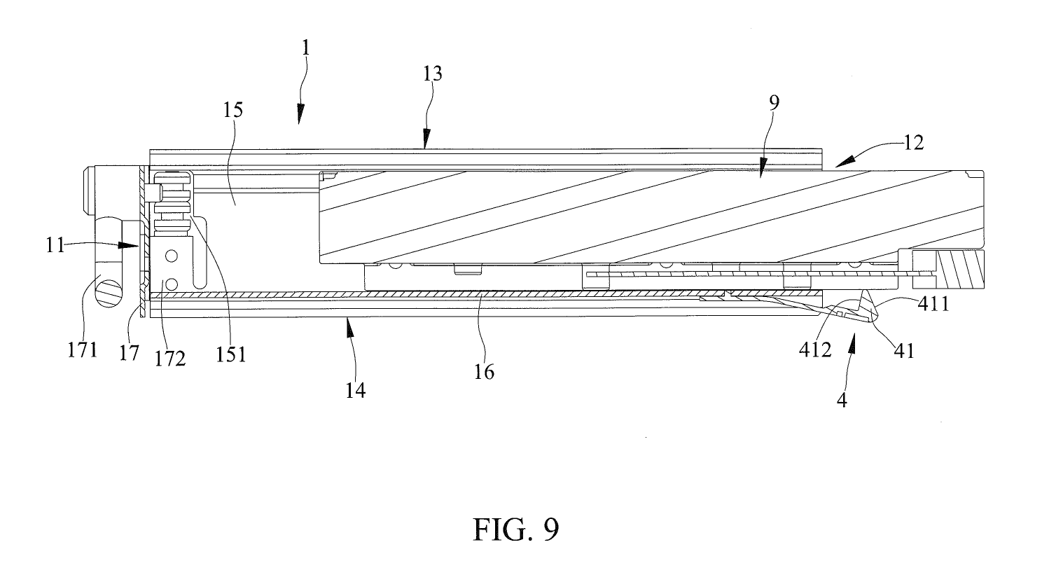

FIGS. 1 through 9 show a first embodiment of a removable computer component module according to the present invention shown in the drawings. The removable computer component module includes a plurality of drive trays 1 and a housing 2 adapted for receiving the plurality of drive trays 1. Each of the plurality of drive trays 1 is adapted for installing a computer component 9, such as a hard drive disk. The plurality of drive trays 1 are selectively engaged and stacked with each other to form a vertical array. The vertical array is mounted into the housing 2 without tools.

Each of the plurality of drive trays 1 includes front and back ends 11 and 12 at two lateral opposite ends thereof, two first and two second engaging portions 13 and 14 arranged at two vertical opposite ends thereof. The two first and two second engaging portions 13 and 14 are horizontally extended from the front end 11 to the back end 12, respectively. The two lateral opposite ends are extended in a first direction perpendicular to the two vertical opposite ends extended in a second direction. The two first engaging portions 13 of one of the plurality of drive trays 1 are engageable with the second engaging portions 14 of another of the plurality of drive trays 1. Each of the two first engaging portions 13 includes a sliding slot 131 horizontally extended from the front end 11 to the back end 12, and two openings 132 respectively formed at two opposite ends of the sliding slot 131. Each of the two second engaging portions 14 includes a sliding rail 141 horizontally extended from the front end 11 to the back end 12 and corresponding to the sliding slot 131 of each of the two first engaging portions 13. Each of the plurality of drive trays 1 includes two lateral portions 15 respectively formed between the two first and two second engaging portions 13 and 14. Preferably, the two first and two second engaging portions 13 and 14, and the two lateral portions 15 of each of the plurality of drive trays 1 are integrally formed as a single. Each of the two lateral portions 15 includes a gap 151 disposed adjacent to the front end 11. A bottom portion 16 is formed between the two lateral portions 15. The computer component 9 is received between the two lateral portions 15 and the bottom portion 16. Each of the plurality of drive trays 1 further includes a front plate 17 threadedly connected with distal ends of the two lateral portions 15. The front plate 17 includes a grip 171 pivotally connected with an end face thereof, two flanges 172 respectively formed opposite to the grip 171 at two opposite ends thereof and connected with the two lateral portions 15, and two apertures 173 respectively formed at two opposite ends thereof. The grip 171 is griped and pulled by a user to cause the drive tray 1 sliding with respect to another drive tray 1. The sliding slot 131 of each of the two first engaging portions 13 has a reversed T-shaped cross section corresponding to a reversed T-shaped cross section of the sliding rail 141 of each of the two second engaging portions 14. The sliding rail 141 of each of the two second engaging portions 14 is engageable into the sliding slot 131 of each of the two first engaging portions 13 via the two openings 132 of each of the two sliding slots 13, so that the plurality of drive trays 1 are stacked with each other to form the vertical array.

The housing 2 is made of an extruded aluminum, which is a good thermal conductor, and reduces die costs. Additionally, the extruded aluminum housing 2 has a metallic appearance looking more precious than that made of plastic, and can easily be cropped in accordance with a height of the vertical array for interoperability to reduce manufacturing cost. The housing 2 includes a bottom section 21, and two third engaging portions 22 formed at two opposite lateral ends of the bottom section 21 and corresponding to and engageable with the two second engaging portions 14 of one of the plurality of drive trays 1. Each of the two third engaging portions 22 has a positioning slot 221. The positioning slot 221 of each of the third engaging portions 22 has a reversed T-shaped cross section corresponding to that of the sliding rail 141 of each of the two second engaging portions 14, and engageable with the sliding rail 141 of each of the two second engaging portions 14 of the nethermost drive tray 1 of the vertical array. Thus, the vertical array is mounted into the housing 2 without tools. The housing 2 further includes two side sections 23 respectively extend form two opposite ends of the bottom section 21. Two fasteners 18 each insert through the two apertures 173 of the front plate 17 of each of the plurality of drive trays 1 and connect to the two side sections 23 of the housing 2. Thus, the vertical array can be mounted into the housing 2 without tools. In a preferred form, each of the fasteners 18 is a hand screw.

A plurality of damping devices 3 each receive into each of the two gaps 151 of the two lateral portions 15 of each of the plurality of drive trays 1. Each of the plurality of damping devices 3 includes a shaft 31 and a plurality of wheels 32. In a preferred form, each of the plurality of wheels 32 can be made of soft material, such as silicone rubber. The shaft 31 of each of the plurality of damping devices 3 inserts through the plurality of wheels 32 and connected with the flange 172 of the front plate 17 of each of the plurality of drive trays 1. When the vertical array is mounted into the housing 2, the plurality of wheels 32 abutted between the computer component 9 and the two side sections 23 of the housing 2 to reduce the friction and provide the damping function.

A plurality of stopper 4 each mounted to the bottom portion 16 of each of the plurality of drive trays 1 and made into rubber with proper elasticity. Each of the plurality of stopper 4 includes a lug 41 formed at a distal end thereof. The lug 41 includes an incline face 411 and a stop face 412 arranged opposite to the incline face 411. Between the incline and stop faces 411 and 412 has an included angle less than ninety degrees. When the computer component 9 enters into the drive tray 1 from the back end 12, the computer component 9 is able to slide upon the incline face 411 of the stopper 4 and abutted against the lug 41 until the computer component 9 abutted against the stop face 412 of the stopper 4 to prevent the computer component 9 disaffiliated from the drive tray 1. Thus the computer component 9 is positioned in the drive tray 1.

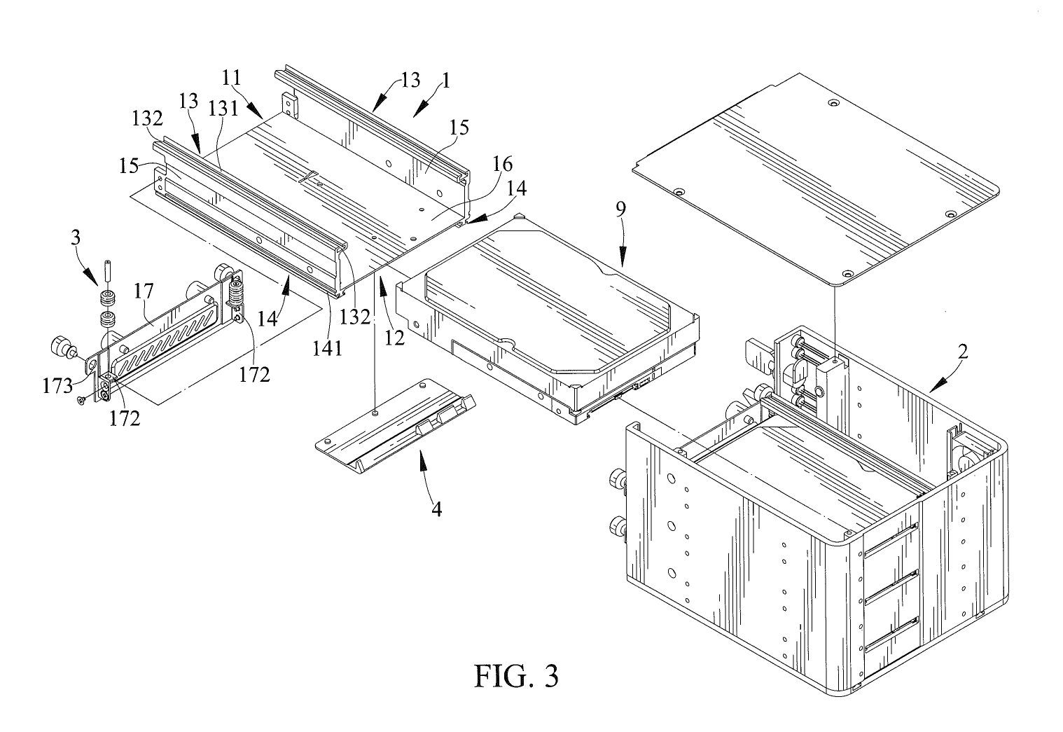

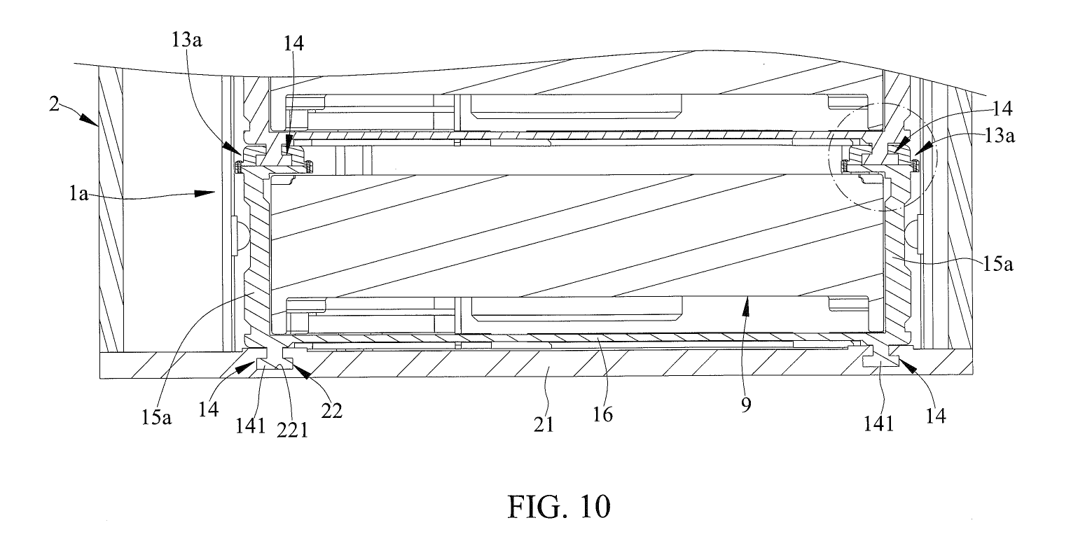

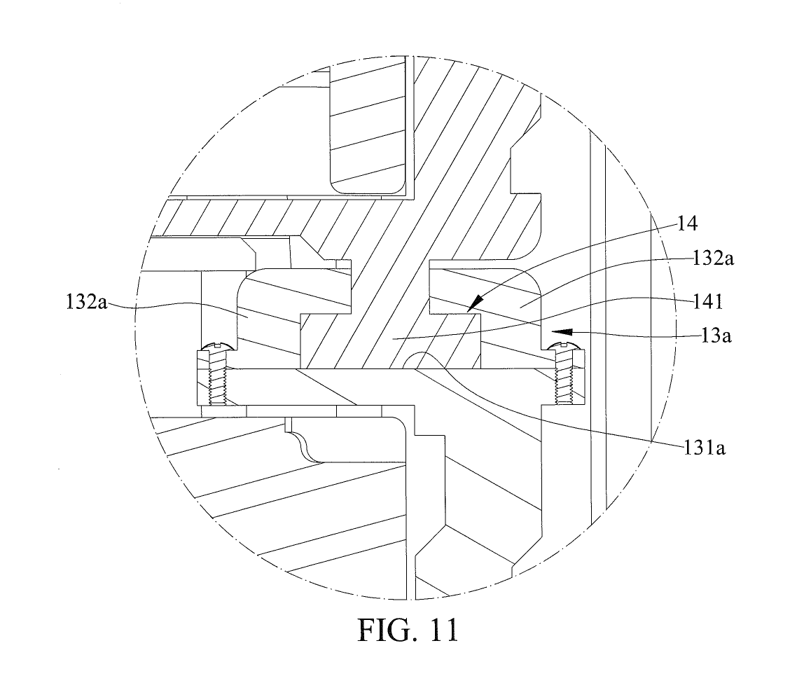

FIGS. 10 and 11 show a second embodiment of the removable computer component module. Specifically, the two first engaging portions 13a and the two lateral portions 15a of each of the plurality of drive trays 2a are formed separately and different from that of each of the plurality of drive trays 1 in FIG. 3. Two L-shaped engaging members 132a are respectively threadedly connected with each of the two lateral portions 15a to form the sliding slot 131a engageable with the sliding rail 141 of each of the two second engaging portions 14.

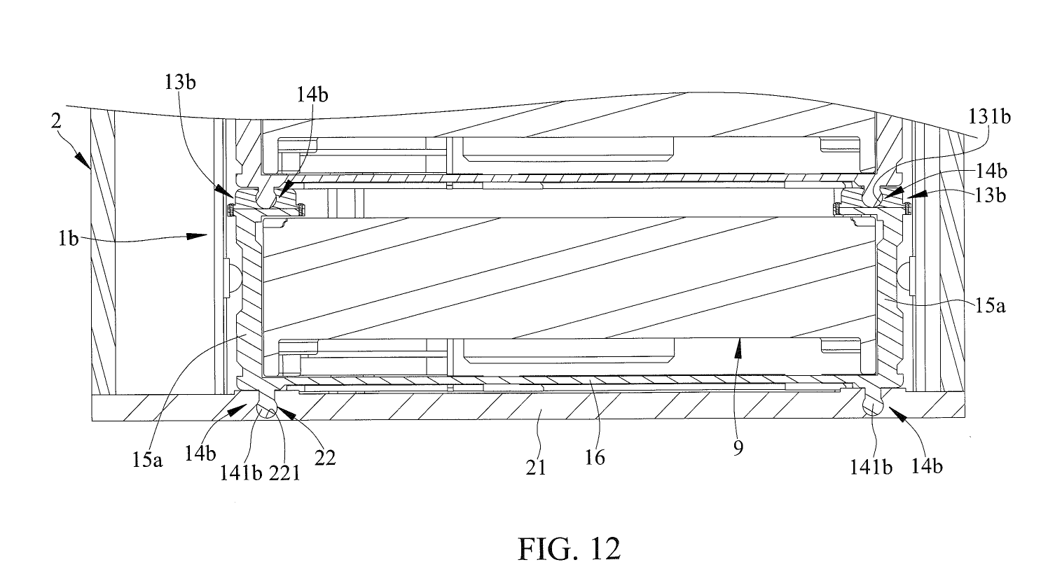

FIG. 12 shows a third embodiment of the removable computer component module. The third embodiment is generally similar to the second embodiment except that the sliding slot 131b of each of the two first engaging portions 13b of each of the plurality of drive trays 1b has a circular cross section corresponding to a circular cross section of the sliding rail 141b of each of the two second engaging portions 14b of each of the plurality of drive trays 1b.

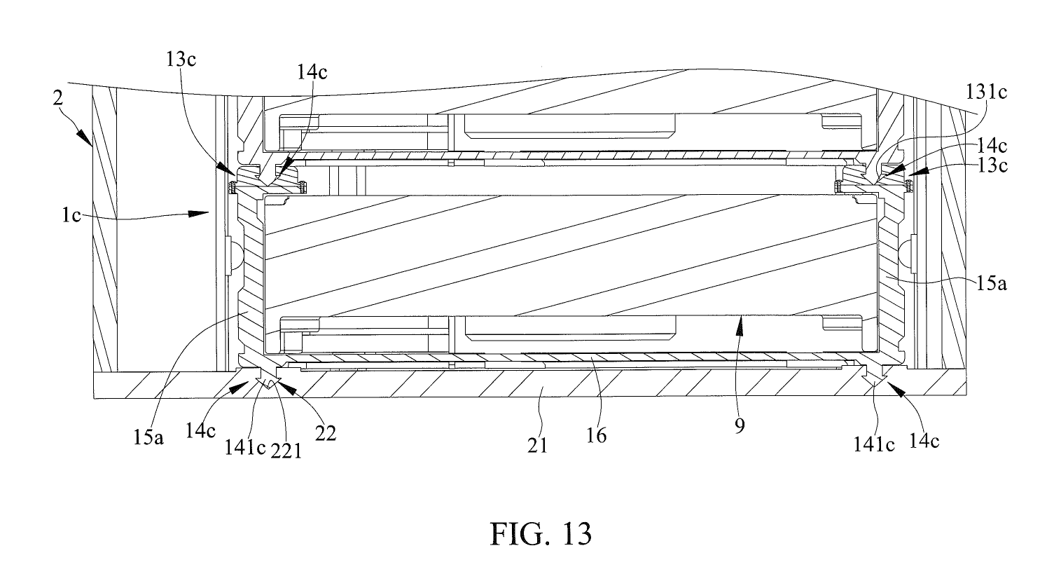

FIG. 13 shows a fourth embodiment of the removable computer component module. The fourth embodiment is generally similar to the second embodiment except that the sliding slot 131c of each of the two first engaging portions 13c of each of the plurality of drive trays 1c has a arrow-shaped cross section corresponding to a arrow-shaped cross section of the sliding rail 141c of each of the two second engaging portions 14c of each of the plurality of drive trays 1c.

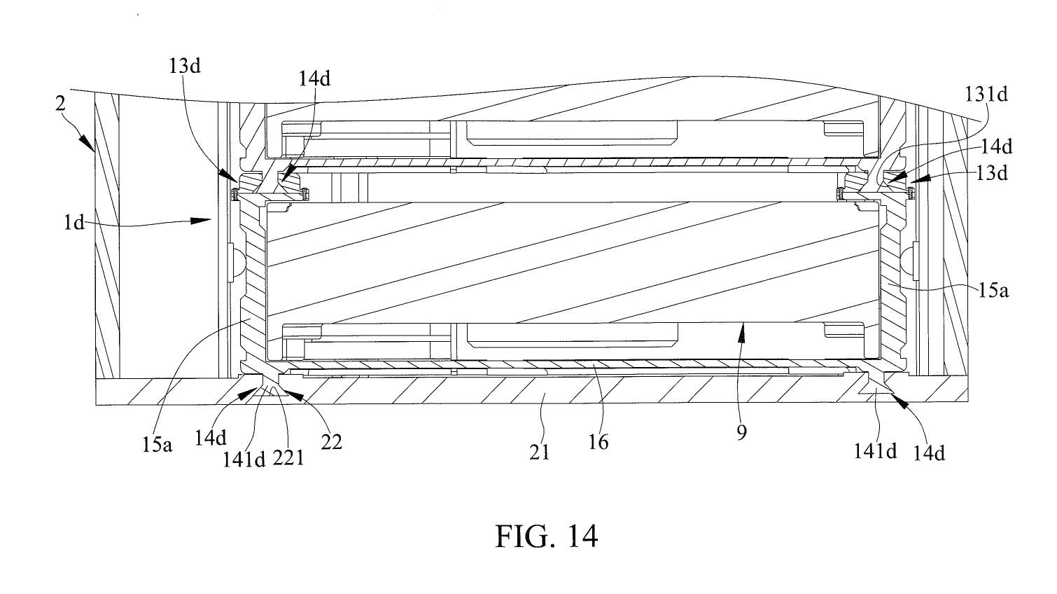

FIG. 14 shows a fifth embodiment of the removable computer component module. The fifth embodiment is generally similar to the second embodiment except that the sliding slot 131d of each of the two first engaging portions 13d of each of the plurality of drive trays 1d has a trapezoid-shaped cross section corresponding to a trapezoid-shaped cross section of the sliding rail 141d of each of the two second engaging portions 14d of each of the plurality of drive trays 1d.

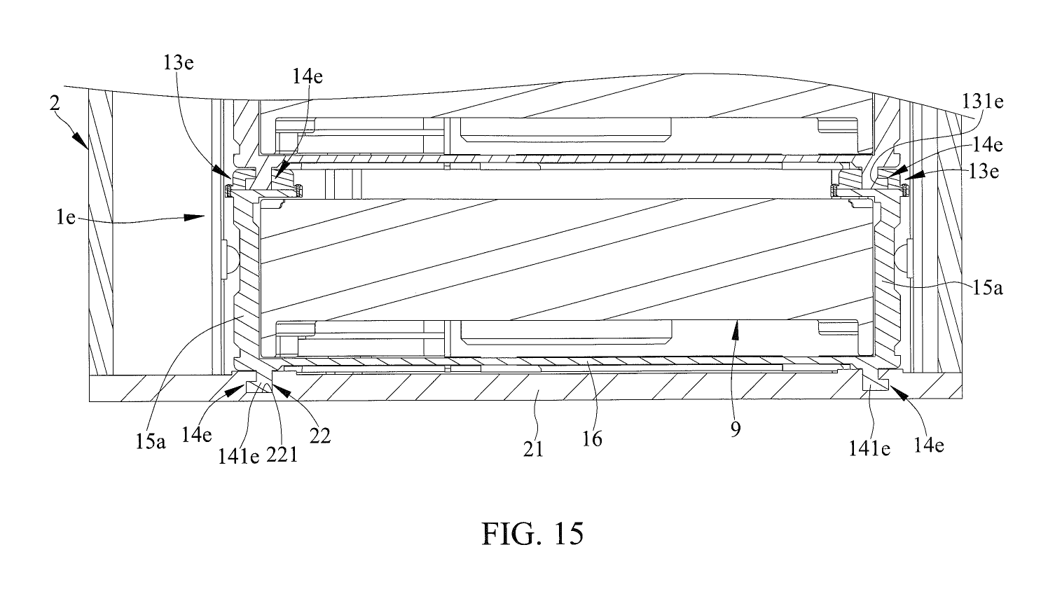

FIG. 15 shows a sixth embodiment of the removable computer component module. The sixth embodiment is generally similar to the second embodiment except that the sliding slot 131e of each of the two first engaging portions 13e of each of the plurality of drive trays 1e has a reversed L-shaped cross section corresponding to a reversed L-shaped cross section of the sliding rail 141e of each of the two second engaging portions 14e of each of the plurality of drive trays 1e.

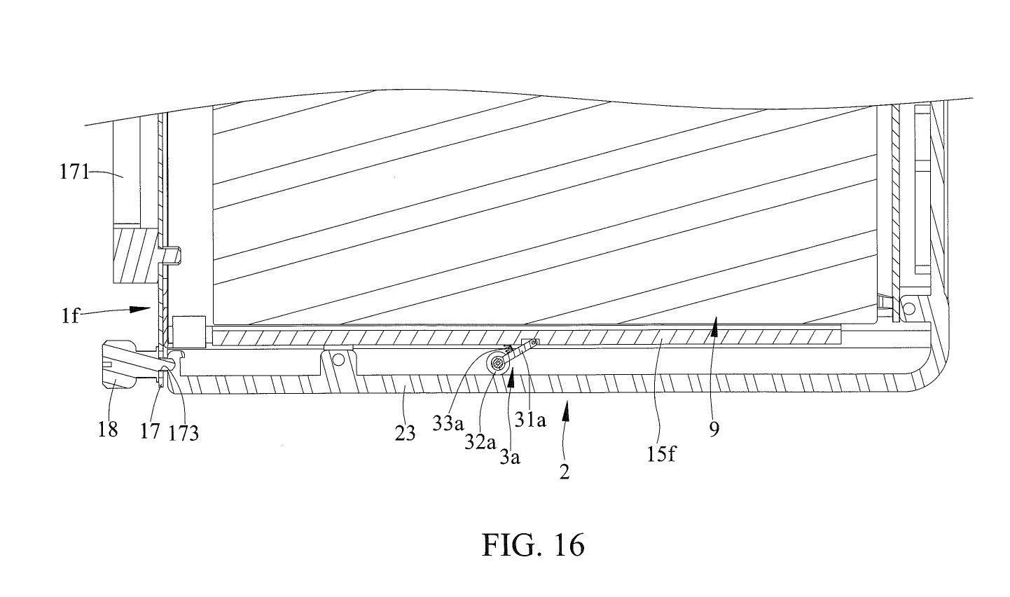

FIG. 16 shows a seventh embodiment of the removable computer component module. The seventh embodiment is generally similar to the first embodiment except that the plurality of damping devices 3a each pivotally connect to each of the two lateral portions 15f of each of the plurality of drive trays 1f. Each of the plurality of damping devices 3a includes a shaft 31a, a plurality of wheels 32a, and an elastic element 33a connected between the shaft 31a and the lateral portion 15f of each of the plurality of drive trays 1f. Two opposite ends of the shaft 31a are respectively pivotally connected with the lateral portion 15f of each of the plurality of drive trays 1f and the plurality of wheels 32a. In a preferred form, each of the plurality of wheels 32a can be made of hard material. The elastic element 33a is a spring. When the vertical array is mounted into the housing 2, the shaft 31a is pivoted with respect to the lateral portion 15f and presses against the elastic element 33a to cause the plurality of wheels 32a abutted against the side sections 23 of the housing 2 to reduce the friction and provide the damping function.

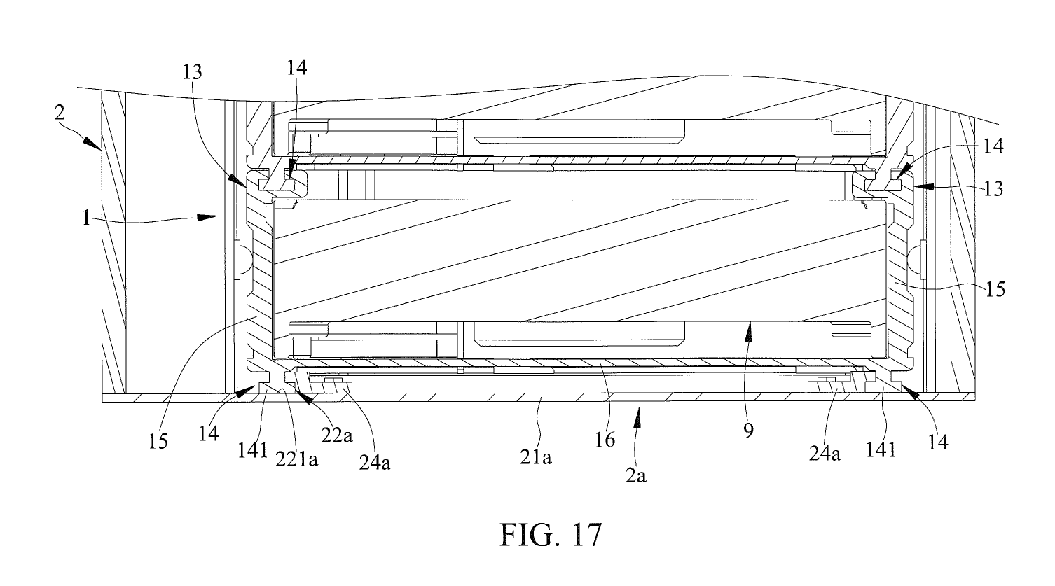

FIG. 17 shows an eighth embodiment of the removable computer component module. The eighth embodiment is generally similar to the first embodiment except that two locating elements 24a are mounted to the bottom section 21a of the housing 2a. Two opposite ends of each of the two locating elements 24a have height drop to form a lower end and a higher end thereof. The lower end of each of the two locating elements 24a is threadedly connected with the bottom section 21a of the housing 2a. The higher end of each of the two locating elements 24a and the bottom section 21a of the housing 2a are formed the third engaging portion 22a. The third engaging portion 22a includes the positioning slot 221a engageable with the nethermost drive tray 1 of the vertical array.

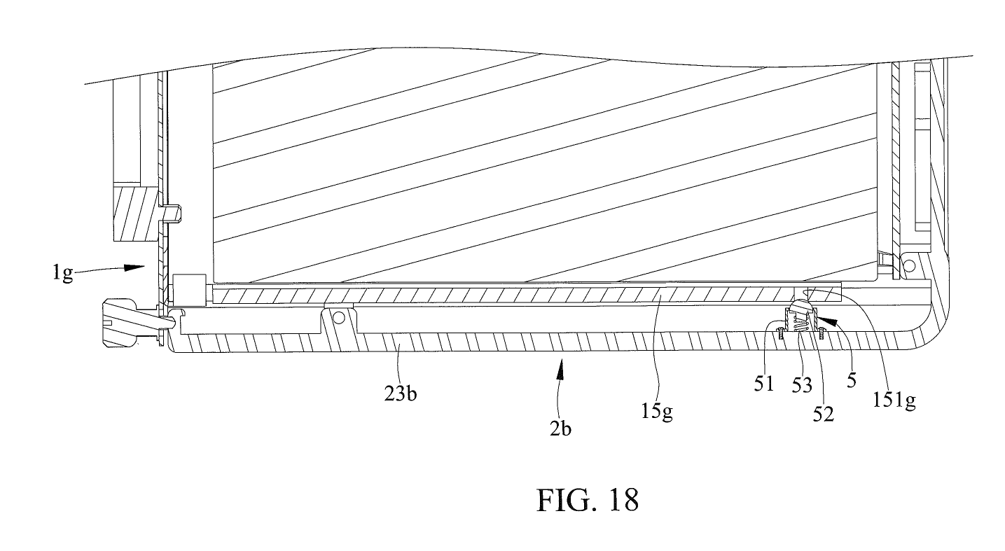

FIG. 18 shows a ninth embodiment of the removable computer component module. Specifically, one of the two lateral portions 15g of each of the plurality of drive trays 1g includes a recess 151g. A fastening device 5 is mounted to one of the two side section 23c of the housing 2b and includes a case 51, an engaging element 52, and a biasing element 53 received in the case 51. The case 51 is hollow and mounted to one of the two side section 23c. The engaging element 52 is received into the case 51 and enables to expose from the case to be engageable with the recess 151g to fix the drive tray 1g to the housing 2b. In a preferred form, the biasing element 53 is a spring and biases against the engaging element 52. The removable computer component module includes the following advantages:

1. The two second engaging portions 14, 14b, 14c, 14d, 14e of one of the plurality of the drive trays 1, 1a, 1b, 1c, 1d, 1e, 1f are engageable with the two first engaging portions 13, 13a, 13b, 13c, 13d, 13e of another of the plurality of the drive trays 1, 1a, 1b, 1c, 1d, 1e, 1f to be quickly stacked with each other to form a vertical array without tools.

2. The two third engaging portions 22, 22a of the housing 2, 2a, 2b are engageable with the two second engaging portions 14, 14b, 14c, 14d, 14e of the nethermost drive tray 1, 1a, 1b, 1c, 1d, 1e, 1f of the vertical array to cause the vertical array mounted into the housing 2, 2a, 2b without tools.

3. The first, second, and third engaging portions 13, 13a, 13b, 13c, 13d, 13e, 14, 14b, 14c, 14d, 14e, and 22, 22a can be formed the sliding slots 131, 131a, 131b, 131c, 131d, 131e, the sliding rails 141, 141b, 141c, 141d, 141e, and the positioning slots 221, 221a adapted for being engageable with each other.

4. The housing 2, 2a, 2b is made of an extruded aluminum, which is a good thermal conductor, and reduces die costs. Additionally, the extruded aluminum housing 2, 2a, 2b has a metallic appearance looking more precious than that made of plastic, and can easily be cropped in accordance with a height of the vertical array for interoperability to reduce manufacturing cost.

5. A plurality of damping devices 3, 3a each are connected to each of the two lateral portions 15 of each of the plurality of drive trays 1 to reduce the friction and provide the damping function.

Now that the basic teachings of the removable computer component module have been explained, many extensions and variations will be obvious to one having ordinary skill in the art. For example, the drive tray 1, and the housing 2 can have shapes different from those shown in the figures.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

What is claimed is:

1. A removable computer component module comprising:
a plurality of drive trays each adapted for receiving a computer component, with each of the plurality of drive trays including front and back ends at two lateral opposite ends thereof, two first and two second engaging portions arranged at two vertical opposite ends thereof, with the two first and two second engaging portions horizontally extended from the front end to the back end;
wherein the two first engaging portions of one of the plurality of drive trays are engageable with the second engaging portions of the other of the plurality of drive trays to form a vertical array.

2. The removable computer component module as claimed in claim 1 further comprising a housing adapted for receiving the vertical array, with the housing including a bottom section, and two third engaging portions formed at two opposite lateral ends of the bottom section, with the two third engaging portions in accordance and engageable with the two second engaging portions of one of the plurality of drive trays.

3. The removable computer component module as claimed in claim 2, wherein each of the two first engaging portions includes a sliding slot horizontally extended from the front end to the back end, with two openings respectively formed at two opposite ends of the sliding slot, wherein each of the two second engaging portions includes a sliding rail horizontally extended from the front end to the back end and corresponding to the sliding slot of each of the two first engaging portions, wherein each of the two third engaging portions has a positioning slot engageable with the sliding rail of each of the two second engaging portions of one of the plurality of drive trays.

4. The removable computer component module as claimed in claim 3, wherein each of the plurality of drive trays includes two lateral portions respectively formed between the two first and two second engaging portions, with each of the two lateral portions includes a gap, with a front plate connected with distal ends of the two lateral portions of each of the plurality of drive trays, with the housing further includes two side sections, with a plurality of damping devices each received into each of the two gaps of the two lateral portions of each of the plurality of drive trays, wherein each of the plurality of damping devices includes a shaft and a plurality of wheels, with each of the plurality of wheels made of soft material, with the shaft of each of the plurality of damping devices inserting through the plurality of wheels and connected with the front plate of each of the plurality of drive trays, with the plurality of wheels abutted between the computer component and the two side sections of the housing to reduce the friction and provide the damping function.

5. The removable computer component module as claimed in claim 4, wherein each of the plurality of drive trays includes a bottom portion formed between the two lateral portions, wherein a plurality of stopper each are mounted to the bottom portion of each of the plurality of drive trays, wherein each of the plurality of stopper is made into rubber and includes a lug formed at a distal end thereof to abut against the computer component to prevent the computer component disaffiliated from the drive tray.

6. The removable computer component module as claimed in claim 5, wherein the lug includes an incline face and a stop face arranged opposite to the incline face, with an included angle formed between the incline and stop faces less than ninety degrees.

7. The removable computer component module as claimed in claim 4, wherein the front plate includes a grip pivotally connected with an end face thereof, with the grip griped and pulled by a user to cause the drive tray sliding with respect to the other drive tray.

8. The removable computer component module as claimed in claim 7, wherein the front plate further includes two flanges respectively formed opposite to the grip at two opposite ends thereof and connected with the two lateral portions, and two apertures respectively formed at two opposite ends thereof, with two fasteners each inserting through the two apertures of the front plate of each of the plurality of drive trays and connect to the two side sections of the housing.

9. The removable computer component module as claimed in claim 3, wherein the two first and two second engaging portions, and the two lateral portions of each of the plurality of drive trays are integrally formed as a single.

10. The removable computer component module as claimed in claim 3, wherein two engaging members are respectively threadedly connected with each of the two lateral portions to form the sliding slot eagageable with the sliding rail of each of the two second engaging portions.

11. The removable computer component module as claimed in claim 3, wherein the sliding slot of each of the two first engaging portions has a reversed T-shaped cross section corresponding to a reversed T-shaped cross section of the sliding rail of each of the two second engaging portions.

12. The removable computer component module as claimed in claim 3, wherein the sliding slot of each of the two first engaging portions of each of the plurality of drive trays has a circular cross section corresponding to a circular cross section of the sliding rail of each of the two second engaging portions of each of the plurality of drive trays.

13. The removable computer component module as claimed in claim 3, wherein the sliding slot of each of the two first engaging portions of each of the plurality of drive trays has a arrow-shaped cross section corresponding to a arrow-shaped cross section of the sliding rail of each of the two second engaging portions of each of the plurality of drive trays.

14. The removable computer component module as claimed in claim 3, wherein the sliding slot of each of the two first engaging portions of each of the plurality of drive trays has a trapezoid-shaped cross section corresponding to a trapezoid-shaped cross section of the sliding rail of each of the two second engaging portions of each of the plurality of drive trays.

15. The removable computer component module as claimed in claim 3, wherein the sliding slot of each of the two first engaging portions of each of the plurality of drive trays has a reversed L-shaped cross section corresponding to a reversed L-shaped cross section of the sliding rail of each of the two second engaging portions of each of the plurality of drive trays.

16. The removable computer component module as claimed in claim 3, wherein each of the plurality of drive trays includes two lateral portions respectively formed between the two first and two second engaging portions, with the housing further including two side sections, with a plurality of damping devices each pivotally connecting to each of the two lateral portions of each of the plurality of drive trays, wherein each of the plurality of damping devices includes a shaft, a plurality of wheels, and an elastic element connected between the shaft and the lateral portion of each of the plurality of drive trays, with two opposite ends of the shaft respectively pivotally connected with the lateral portion of each of the plurality of drive trays and the plurality of wheels, with each of the plurality of wheels made of hard material, with the shaft pivoted with respect to the lateral portion and pressing against the elastic element to cause the plurality of wheels abutted against the side sections of the housing to reduce the friction and provide the damping function.

17. The removable computer component module as claimed in claim 3, wherein two locating elements are mounted to the bottom section of the housing, with two opposite ends of each of the two locating elements formed a lower end and a higher end thereof, with the lower end of each of the two locating elements threadedly connected with the bottom section of the housing, with the higher end of each of the two locating elements and the bottom section of the housing formed the third engaging portion, with the third engaging portion including the positioning slot engageable with the drive tray.

18. The removable computer component module as claimed in claim 3, wherein one of the two lateral portions of each of the plurality of drive trays includes a recess, wherein a fastening device includes a case, an engaging element, and a biasing element received in the case, with the case being hollow and mounted to one of the two side section, with the engaging element received into the case and exposed from the case to be engageable with the recess to fix the drive tray to the housing.
